(19) United States
(12) Patent Application Publication
(10) Pub. No.: US 2016/0205453 A1
(43) Pub. Date: Jul. 14, 2016

(54) EXTERNAL SPEAKER/MICROPHONE APPARATUS FOR USE WITH AN ELECTRICAL DEVICE FOR PROVIDING AUDIO SIGNALS AND/OR FOR VOICE COMMUNICATION

(71) Applicant: BINAURIC SE, Hallbergmoos (DE)

(72) Inventors: Detlef WIESE, Haimhausen (DE); Pierre-Henri SAMION, Menil (FR); Bernd GEISER, Aachen (DE); Hauke KRÜGER, Aachen (DE)

(21) Appl. No.: 14/913,673

(22) PCT Filed: Aug. 23, 2013
(86) PCT No.: PCT/EP2013/067534

§ 371 Date: Feb. 22, 2016

(51) Int. Cl. H04R 1/02; H04R 3/00; H04R 5/027; H04R 1/32

(52) U.S. Cl. CPC H04R 1/025; H04R 1/326; H04R 3/005; H04R 5/027; H04R 2430/20; H04R 2420/05

(57) ABSTRACT

The present invention relates to an external speaker/microphone apparatus for use with an electrical device for providing audio signals and/or for voice communication. The apparatus comprises: one or more speakers and one or more microphones; and a housing that encloses the one or more speakers and the one or more microphones. The shape of the housing is formed from a number of twelve or more flat surfaces. Through the use of a housing, the shape of which is formed from a number of twelve or more flat surfaces, a more flexible orientation of the external speaker/microphone apparatus—and therewith of the one or more speakers and the one or more microphones to the user(s)—is made possible. At the same time, the use of flat surfaces allows for a sufficient stableness.

### BACKGROUND

1. Technical Field

The present invention relates to an external speaker/microphone apparatus for use with an electrical device for providing audio signals and/or for voice communication.

2. Description of the Related Art

External speaker/microphone apparatuses that are provided and suited for use with an electrical device for providing audio signals and/or for voice communication, e.g., a computer, such as a desktop, laptop, or tablet computer, an MP3 player, a suitable radio, a smartphone, such as an Apple iPhone or a Samsung Galaxy, a PDA (Personal Digital Assistant), or the like, are generally known. One example is the so-called BIG JAMBOX, from the company Jawbone. The BIG JAMBOX allows for the reception of digital audio signals, e.g., MP3-compressed music data, which are transmitted wirelessly via Bluetooth from an electrical device for providing audio signals and/or for voice communication. In addition, a microphone is integrated so that the BIG JAMBOX can also be used as a speaker phone, e.g., for phone calls or video chats via Skype, GoogleTalk, or FaceTime. As further examples of known external speaker/microphone apparatuses with comparable features, the so-called Pill from the company Beats by Dr. Dre or the so-called Flip from the company JBL can be mentioned.

The above-described external speaker/microphone apparatuses have, first of all, the disadvantage that they are not very flexible with respect to the orientation of the speaker(s) or the microphone(s) to the user(s). For instance, the BIG JAMBOX is formed in a shape of a cuboid so that the speaker and the microphone, which are collectively provided at one of the four long sides, can be oriented in the “height” direction (i.e., with regard to a rotation around the longitudinal axis) without assistive equipment, e.g., by placing a wedge-shaped object or the like underneath, only in 90° steps (0°, 90°, 180°, and 270°). In contrast, the Pill is formed substantially in the shape of an elongated cylinder (with rounded corners). Therewith, it could be placed in the circumferential direction of the cylinder practically under arbitrary angles on a support, e.g., a table; however, such placement does not provide for a sufficient stableness so that the external speaker/microphone apparatus easily starts rolling on a slightly inclined support or upon already a light shaking of the support. For this reason, the Pill is provided at its bottom side with a flat pedestal so that it can only reasonably be oriented in the “height” direction in a single direction. Finally, the Flip is also formed substantially in the shape of an elongated cylinder with an integrated pillar. This external speaker/microphone apparatus can reasonably be oriented in the “height” direction only in two different directions.

Further problems and/or disadvantages that are related to the above-described external speaker/microphone apparatuses relate to the audio quality as well as the usability with regard to the user friendliness thereof. For instance, with the above-described external speaker/microphone apparatuses, users are only informed about a function and/or a status, a low power status of the comprised one or more batteries, by annoying beeps or artificial sounds.

The present invention has been made in view of these problems and/or disadvantages and embodiments described herein aim at overcoming—or at least reducing—one or more of these problems and/or disadvantages.

### BRIEF SUMMARY

Embodiments described herein provide an external speaker/microphone apparatus that, on the one hand, allows for a more flexible orientation of the speaker(s) or the microphone(s) to the user(s) and that, on the other hand, also provides for a sufficient stableness. Embodiments described herein can provide an improved audio quality and an improved usability with regard to user friendliness. It is noted that some embodiments may only provide one or some of the above advantages whereas other embodiments may provide all of the above advantages.

### a) First Aspect of Embodiments Described Herein

In various embodiments, an external speaker/microphone apparatus for use with an electrical device for providing audio signals and/or for voice communication is presented, wherein the apparatus comprises:
one or more speakers and one or more microphones; and
a housing that encloses the one or more speakers and the one or more microphones,
wherein the shape of the housing is formed from a number of twelve or more flat surfaces.

This aspect is based on the idea that through the use of a housing, the shape of which is formed from a number of twelve or more flat surfaces, as compared to, e.g., a cuboid (six flat surfaces), a more flexible orientation of the external speaker/microphone apparatus—and therewith of the one or more speakers and the one or more microphones to the user(s)—is made possible. At the same time, the use of flat surfaces allows for a sufficient stableness.

It should be noted that the twelve or more flat surfaces are all differently positioned and/or oriented in space, i.e., no two of the twelve or more flat surfaces are positioned in the same spatial plane. Moreover, the maximum number of flat surfaces that is contemplated to be used for the housing is thirty, because for larger numbers, the decrease in stableness is thought to become too large.

In at least one embodiment, each of the flat surfaces has the form of a regular polygon. A regular polygon, e.g., a regular triangle, a regular quadrangle (square), a regular pentagon, etc., is characterized by the fact that all of its sides have the same length and that all of its internal angles are of equal size. Therewith, it nicely approximates the form of a circle (i.e., a circle can be thought of as the “limit” of a regular polygon with an infinite number of corners). As a result, flat surfaces that have the form of a regular polygon provide a very good stableness as compared to corresponding irregular polygons. For instance, a flat surface that has the form of a regular quadrangle (square) provides a better stableness than a corresponding elongated rectangle (irregular quadrangle), which can be knocked over much more easily in the direction perpendicular to the longitudinal axis.

In at least one embodiment, the flat surfaces all have the same shape and size. Therewith, an equally good stableness results for different orientations of the external speaker/microphone apparatus—and therewith the one or more speakers and the one or more microphones to the user(s). Additionally, the manufacturing of the housing can be simplified if the flat surfaces all have the same shape and size.

In at least one embodiment, the housing is formed in the shape of an icosahedron. An icosahedron is a geometric body, whose shape is formed from twenty regular triangles of equal size as surfaces. It therefore provides all of the above-mentioned advantages. Moreover, the shape of an icosahedron provides a good compromise between, on the one hand, flexibility with regard to the orientation and, on the other hand, stableness.

In at least one embodiment, the housing comprises in a first region at the outside a synthetic material, for example, a silicon, and is provided in a second region, which is, for example, made of a metal, at least partially with a plurality of holes for improving the passage of audio waves.

### b) Second Aspect of Embodiments Described Herein

In various embodiments, an external speaker/microphone apparatus for use with an electrical device for providing audio signals and/or for voice communication is presented, wherein the apparatus comprises:
one or more speakers and one or more microphones; and
a housing that encloses the one or more speakers and the one or more microphones,
wherein the shape of the housing is formed in substantially a U-shape for being worn by a user on the shoulders around the neck.

In at least one embodiment, the housing comprises a first part and a second part that can be folded via a central hinge.

In at least one embodiment, the housing comprises in a first region at the outside a synthetic material, for example, a TPR, and is provided in a second region, which is, for example, made from a soft leatherette, at least partially with a plurality of holes for improving the passage of audio waves.

### c) Third Aspect of Embodiments Described Herein

In various embodiments, an external speaker/microphone apparatus for use with an electrical device for providing audio signals and/or for voice communication, comprising:
one or more speakers and one or more microphones,
wherein the external speaker/microphone apparatus is configured as an over- or on-the-ear headphone, or as an in-ear phone, or is arranged on glasses for being worn by a user.

### d) Further Features and Functionalities

The following further features and functionalities relate—unless explicitly specified elsewise—to the external speaker/microphone apparatus according to any of the three above-described aspects:

In some embodiments, the one or more microphones comprise a first microphone group comprising a first and a second microphone, wherein the apparatus is adapted to simultaneously acquire first and second audio signals by means of the first and the second microphone of the first microphone group and to process the first and second audio signals using audio beamforming for providing a beamformed audio signal or to process the first audio signal as a wanted signal and the second audio signal as an interference or room signal and to clean-up the first audio signal using the second audio signal for providing a cleaned-up audio signal.

In at least one embodiment, the first and the second microphone of the first microphone group are arranged with a distance therebetween between 1.0 cm and 2.3 cm, between 1.3 cm and 2.0 cm, or between 1.5 cm to 1.8 cm.

In other embodiments, the one or more microphones comprise a second microphone group comprising a first and a second microphone, wherein the apparatus is adapted to simultaneously acquire first and second audio signals by means of the first and the second microphone of the second microphone group for providing binaural-like audio signals.

In at least one embodiment, the first and the second microphone (e.g., 32, 33 in FIG. 1) of the second microphone group are arranged with a distance therebetween between 6 cm and 18 cm, between 8 cm and 16 cm, or between 10 cm and 14 cm.

In some embodiments, the first and the second microphone of the first microphone group are arranged in a plane that is perpendicular to a connecting line of the first and the second microphone of the second microphone group and that separates the connection line midway between the first and the second microphone of the second microphone group.

In other embodiments, the first and the second microphone of the second microphone group are arranged with a distance therebetween between 11 cm and 22 cm, between 13 cm and 20 cm, or between 15 cm and 18 cm.

The external speaker/microphone apparatus may also comprise:
an audio cable for connecting the apparatus to an electrical device for providing audio signals and/or for speech communication,
wherein the apparatus is adapted to detect whether or not it is connected via the audio cable to the electrical device, and
(i) if a connection is detected, to use a cable mode for receiving audio signals via the audio cable from the electrical device and/or for transmitting audio signals via the audio cable to the electrical device, and
(ii) if a connection is not detected, to use a wireless mode for receiving audio signals wirelessly from the electrical device and/or for transmitting audio signals wirelessly to the electrical device.

The audio cable may comprise an indicator element for indicating to a user whether the apparatus uses the cable mode.

The external speaker/microphone apparatus may also comprise:
at least one audio jack socket; and
an audio cable for connecting the apparatus to an electrical device for providing audio signals and/or for speech communication, wherein the audio cable comprises at least one audio jack plug,
wherein the at least one audio jack plug can be detachably coupled with the at least one audio jack socket, wherein the coupling is such that the audio cable can be utilized by a user as a handle for carrying the apparatus.

The coupling may make use of at least magnetic force.

The external speaker/microphone apparatus may also comprise:
an audio connector with at least four poles,
wherein the apparatus is adapted to switch a pole configuration of the audio connector between at least
(i) a first pole configuration, in which a first pole is configured to output audio signals that are based on audio signals acquired by at least one of the one or more microphones, and in which a second and a third pole are configured to input audio signals for reproduction by at least one of the one or more speakers, and
(ii) a second pole configuration, in which a first pole is configured to output audio signals that are based on audio signals acquired by at least the first microphone of the second microphone group, in which a second pole is configured to output audio signals that are based on audio signals acquired by at least the second microphone of the second microphone group, and in which a third pole is configured to input audio signals for reproduction by at least one of the one or more speakers.

In some embodiments, external speaker/microphone apparatus is adapted to inform a user about a function and/or a status by means of a voice prompt, wherein the apparatus is adapted to alternate, for a same function and/or status, between different voice prompts.

In other embodiments, the external speaker/microphone apparatus is adapted to inform a user about a function and/or a status by means of a voice prompt, wherein the apparatus is adapted to adjust at least one audio characteristic of the voice prompt according to a corresponding at least one audio characteristic of a music reproduced by at least one of the one or more speakers.

In at least one embodiment, the at least one audio characteristic includes a rhythm and/or a pitch and/or a harmony and/or a level.

In various embodiments, the external speaker/microphone apparatus is adapted to inform a user about a function and/or a status by means of a voice prompt, wherein the apparatus is adapted to apply a cross-fade from a music reproduced by at least one of the one or more speakers to the voice prompt and vice versa.

The external speaker/microphone apparatus may also comprise:
an accelerometer for measuring an acceleration and/or gravity of the apparatus,
wherein the apparatus is adapted to control a function in dependence of the measured acceleration and/or gravity.

The external speaker/microphone apparatus may also comprise:
an accelerometer for measuring an acceleration and/or gravity of the apparatus,
wherein the apparatus is adapted to determine a misplacement in dependence of the measured acceleration and/or gravity.

Further foreseen is a system, comprising:
the external speaker/microphone apparatus according to any of claims 21 to 26, and
a software program for being run by the electrical device for providing audio signals and/or for voice communication,
wherein the software program when being run by the electrical device allows a user to record and/or adapt a voice prompt.

It shall be understood that the external speaker/microphone apparatus described herein can also be any combination of the dependent claims or above embodiments with the respective independent claim.

It is noted that the external speaker/microphone apparatus according to any of the above-described three aspects is adapted for being able to make use of a wireless mode for receiving audio signals wirelessly from the electrical device and/or for transmitting audio signals wirelessly to the electrical device.

These and other aspects will be apparent from and elucidated with reference to the embodiments described hereinafter.

### BRIEF DESCRIPTION OF THE SEVERAL VIEWS OF THE DRAWINGS

In the following drawings:

FIG. 1 shows schematically and exemplarily a first view of a first embodiment of an external speaker/microphone apparatus for use with an electrical device for providing audio signals and/or for voice communication,

FIGS. 2a and 3b show schematically and exemplarily a “beampattern” of a differential audio beamformer in dependence of frequency and angle of incidence,

FIG. 3 shows schematically and exemplarily a second view of the external speaker/microphone apparatus shown in FIG. 1,

FIG. 4 shows schematically and exemplarily a first view of a second embodiment of an external speaker/microphone apparatus for use with an electrical device for providing audio signals and/or for voice communication,

FIGS. 5a and 5b show schematically and exemplarily a second view of the external speaker/microphone apparatus shown in FIG. 4, and

FIG. 6 shows schematically and exemplarily a view of a third embodiment of an external speaker/microphone apparatus for use with an electrical device for providing audio signals and/or for voice communication.

### DETAILED DESCRIPTION

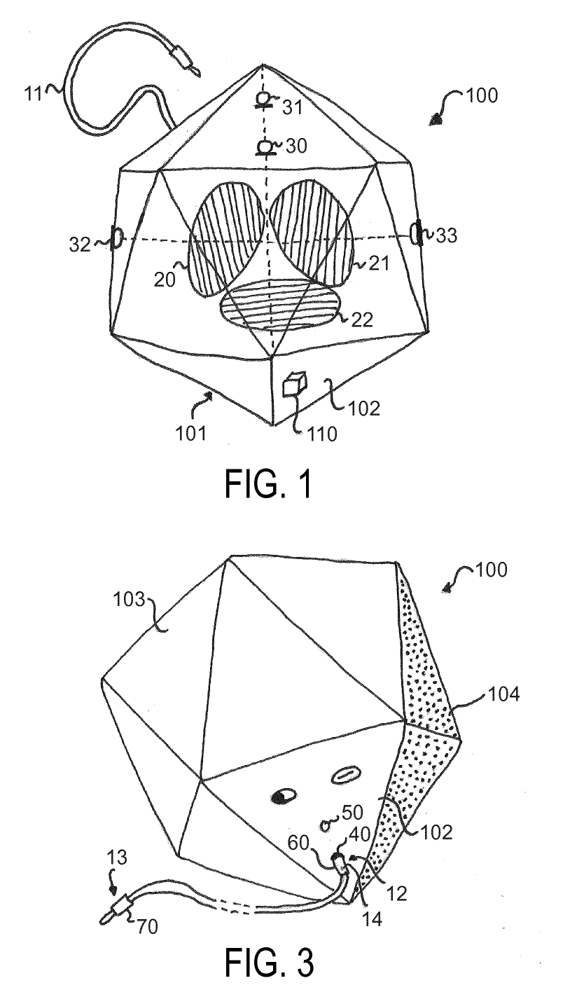

FIG. 1 shows schematically and exemplarily a first view of a first embodiment of an external speaker/microphone apparatus 100 for use with an electrical device (not shown in this figure) for providing audio signals and/or for voice communication, e.g., a computer, such as a desktop, laptop, or tablet computer, an MP3 player, a suitable radio, a smartphone, such as an Apple iPhone or a Samsung Galaxy, a PDA (Personal Digital Assistant), or the like. In the following, it is assumed that the electrical device is a smartphone.

The external speaker/microphone apparatus 100, in this embodiment, comprises a first and a second speaker 20, 21 and a passive radiator 22 for reproducing low audio frequencies, and four microphones 30, 31, 32, 33, as well as a housing 101 that encloses the first and the second speaker 20, 21, the passive radiator 22, and the four microphones 30, 31, 32, 33. The shape of the housing 101 is formed, here, from a number of twenty flat surfaces 102 that each have the form of a regular triangle and that are all of the same size. In other words, the housing 101, here, is formed in the shape of an icosahedron.

The four microphones 30, 31, 32, 33 constitute two different microphone groups. A first microphone group of the external speaker/microphone apparatus 100 comprises a first and a second microphone 30, 31 that are arranged with a distance therebetween between 1.5 cm and 1.8 cm. More generally, however, the first and the second microphone 30, 31 of the first microphone group may also be arranged with a distance therebetween between 1.3 cm and 2.0 cm or even between 1.0 cm and 2.3 cm. The external speaker/microphone apparatus 100 is adapted to simultaneously acquire first and second audio signals by means of the first and the second microphone 30, 31 of the first microphone group and to process the first and second audio signals using audio beamforming for providing a beamformed audio signal. This will be explained in more detailed in the following.

Beamforming is a well-known technique that can be used in the field of audio processing for achieving, e.g., directional reception with an array of microphones. It is based on combining the audio signals acquired by each microphone of the array in such a way that audio signals at particular angles experience constructive interference whereas audio signals at other angles experience destructive interference.

A suitable differential audio beamforming that can be used by the external speaker/microphone apparatus 100 for processing the first and second audio signals acquired by means of the first and the second microphone 30, 31 of the first microphone group for providing a beamformed audio signal can be based on the principle described, e.g., in the papers by Gary W. Elko and Anh-Tho Nguyen Pong, “A simple adaptive first-order differential microphone”, in IEEE Workshop on Applications of Signal Processing to Audio and Acoustics, New Paltz, N.Y., USA, October 1995 and by Henning Puder, “Acoustic Noise Control: An Overview of Several Methods Based on Applications in Hearing Aids”, in IEEE Pacific Rim Conference on Communications, Computers and Signal Processing, Victoria, BC, Canada, August 2009.

In order to reduce the influence of a mismatch (in terms of gain) of the first and second audio signals acquired by means of the first and the second microphone 30, 31 of the first microphone group on the differential audio beamforming, a gain matching technique is used. The basic idea behind this gain matching technique is as follows:

(i) Assuming a point-like acoustic source s(t), the first and second audio signals acquired by means of the first and the second microphone 30, 31 of the first microphone group can be written as:

$${x}_{1} ( t ) = s ( t + \frac{d}{2 c} cos θ ) and {x}_{2} ( t ) = g \cdot s ( t - \frac{d}{2 c} cos θ )$$

where d is the distance between the microphones, θ is the angle of incidence, and c is the speed of sound c. The factor g represents a possible microphone gain mismatch, which can results from the fact that microphones may slightly deviate for each other in terms of audio capturing characteristics.

With the system equation of the differential audio beamforming being:

y(t)=(x₁(t−T)−x₂(t))−a+(x₁(t)−x₂(t−T))

$$T = \frac{d}{c}$$

where aε[0,1] is the steering coefficient and is the time delay used to align the acquired first and second audio signals, we get:

$$y ( t ) = [ s ( t - T + \frac{d}{2 c} cos θ ) - g \cdot s ( t - \frac{d}{2 c} cos θ ) ] \cdot a + [ s ( t + \frac{d}{2 c} cos θ ) - g \cdot s ( t - T - \frac{d}{2 c} cos θ ) ] .$$

The Fourier transform of this equation yields:

$$Y ( j ω ) = S ( j ω ) \cdot \{ [ {e}^{j ω ( \frac{d}{2 c} cos θ - T )} - g \cdot {e}^{- j ω \frac{d}{2 c} cos θ} ] \cdot a + [ {e}^{j ω \frac{d}{2 c} cos θ} - g \cdot {e}^{- j ω ( \frac{d}{2 c} cos θ + T )} ] \} .$$

Inserting

$$T = \frac{d}{c}$$

and factoring out some exponentials then gives the transfer function:

$$\frac{Y ( j ω )}{S ( j ω )} = {e}^{j ω \frac{d}{2 c} cos θ} \{ [ 1 - g \cdot {e}^{- j ω \frac{d}{c} ( cos θ - 1 )} ] \cdot {e}^{- j ω \frac{d}{c}} \cdot a + [ 1 - g \cdot {e}^{- j ω \frac{d}{c} ( cos θ + 1 )} ] \} .$$

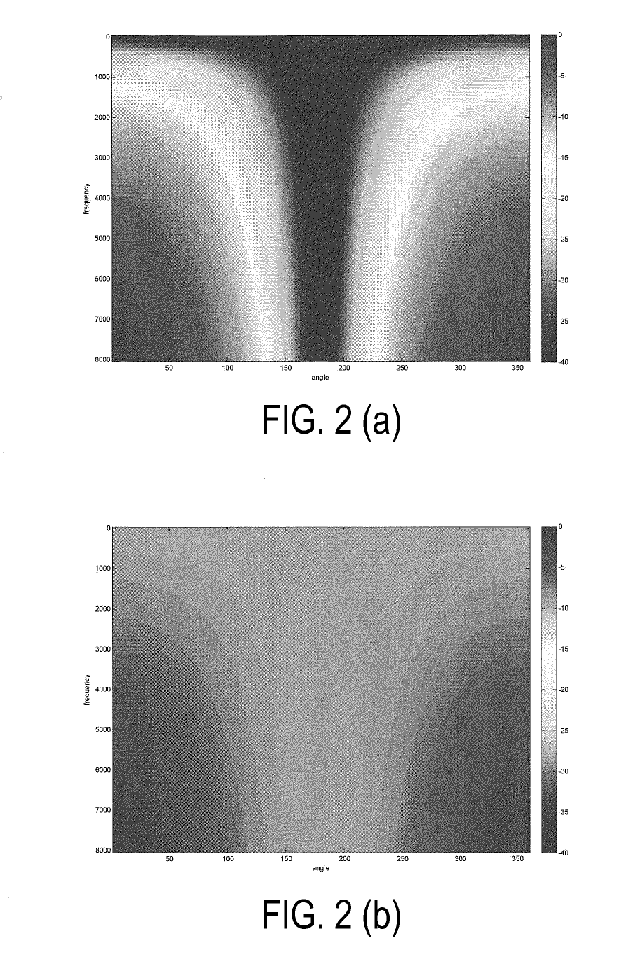

The absolute value of this transfer function can be used to plot the “beampattern”, i.e., the attenuation of the differential audio beamforming in dependence of frequency and angle of incidence (see FIGS. 2a and 2b).

For the matched case, the typical beam pattern as shown in FIG. 2 (a) is found. However, it has been found by the inventors that already for a small mismatch, the performance of the beamforming deteriorates rapidly (see FIG. 2 (b)).

(ii) The above observations show that a gain mismatch between the first and second audio signals acquired by means of the first and the second microphone 30, 31 of the first microphone group cannot easily be tolerated. Therefore, a gain matching technique is used, which enforces matched gains at both microphones before further processing. This is achieved by computing a correction gain factor \tilde{g} based on second order statistics of the two signal x₁(k) and x₂(k):

$${\tilde{g}}_{opt} ( λ ) = \sqrt{\frac{E \{ {x}_{1}^{2} \}}{E \{ {x}_{2}^{2} \}}} .$$

Since in practice, the involved audio signals are not stationary, the second order statistics are approximated for each audio frame and afterwards recursively smoothed:

$$\tilde{g} ( λ ) = \tilde{g} ( λ - 1 ) \cdot γ + \sqrt{\frac{\hat{E} \{ {x}_{1}^{2} \}}{\hat{E} \{ {x}_{2}^{2} \}}} \cdot ( 1 - γ )$$

where Ê{x₁²} and Ê{x₂²} are the (estimated) short term powers of the acquired first and second audio signals. These short term powers can simply be computed as the powers within the current audio frame which is being processed. To apply the gain matching technique on a sample-by-sample basis over an audio frame of length L, a linear interpolation is conducted before the second audio signal is multiplied by the (now interpolated) gains:

$${\hat{x}}_{2} ( k + λ L ) = {x}_{2} ( k + λ L ) \cdot [ \frac{L - k}{L} \cdot \tilde{g} ( λ - 1 ) + \frac{k}{L} \cdot \tilde{g} ( λ ) ] .$$

A potential disadvantage of this approach could be that the amplification/attenuation of a microphone leads to mismatching signal-to-noise ratios between the channels. However, it has been found by the inventors that this is usually not problematic (at least if the SNR mismatch is not excessively large). The gain matching technique has been found to be very effective in practical experiments; the differential audio beamforming actually remains functional for typical gain variations. The smoothing constant γ can be set to a value close to one (e.g., 0.95) so that the correction gains do not vary too rapidly which could produce audible artifacts.

(iii) The (angular) position of the spatial zero of the first microphone group can be controlled with the factor aε[0,1], yielding notch angles between 90° and 180° (and the second symmetric notch between 270° and 180°). As in the above mentioned papers by Elko/Pong and by Puder, an NLMS (normalized least mean square) algorithm can be used to adapt the factor a and thus the notch positions to the current acoustic environment. By steering the notch in the appropriate position, a dominant interferer in the rear half plane can be eliminated.

The basic idea of the NLMS algorithm is to minimize the output energy of the microphone group under the constraint that the factor a remains in the interval [0,1], i.e., that the notches are located in the rear half plane. The squared output of the microphone group is:

y²(t)=(x₁(t−T)−X₂(t))²a²(x₁(t)−x₂(t−T))²+2a(x₁(t)−x₂(t−T))(x₁(t−T)−x₂(t)).

The LMS algorithm pursues a steepest decent approach, i.e.:

$$a ( t + 1 ) = a ( t ) - μ \frac{d {y}^{2}}{d a}$$

with the step size μ. This, after performing some algebra, leads to the update equation:

$$a ( t + 1 ) = a ( t ) + 2 μ \frac{{x}_{2} ( t ) - {x}_{1} ( t - T )}{E \{ {( {x}_{2} ( t ) - {x}_{1} ( t - T ) )}^{2} \}} y ( t )$$

which includes the energy normalization in the denominator, rendering the approach an NLMS algorithm. In addition to the above equation, the outcome a(t+1) needs to be limited to the valid range [0,1]. For the power computation in denominator, as for gain matching, a short term power over the current audio frame can be used with a certain gain floor (e.g., 5·10⁻⁴) to cope with low-energy frames. The step size may be small in order to avoid heavy fluctuations, e.g., μ=10⁻³.

With returning reference to FIG. 1, a differential audio beamforming as described above can be used by the external speaker/microphone apparatus 100 to process the first and second audio signals acquired by the first and the second microphone 30, 31 of the first microphone group for providing a beamformed audio signal.

In this embodiment, a second microphone group of the external speaker/microphone apparatus 100 comprises a first and a second microphone 32, 33 that are arranged with a distance therebetween between 10 cm and 14 cm in order to mimic the distance between the ears in human perception. More generally, however, the first and the second microphone 32, 33 of the second microphone group may also be arranged with a distance therebetween between 8 cm and 16 cm or even between 6 cm and 18 cm. The external speaker/microphone apparatus 100 is adapted to simultaneously acquire first and second audio signals by means of the first and the second microphone 32, 33 of the second microphone group for providing binaural-like audio signals, i.e., audio signals that are intended to create a 3D stereo sound sensation for the listener.

Here, the first and the second microphone 30, 31 of the first microphone group are arranged in a plane (shown by the stippled vertical line) that is perpendicular to a connecting line (shown by the stippled horizontal line) of the first and the second microphone 32, 33 of the second microphone group and that separates the connection line substantially midway between the first and the second microphone 32, 33 of the second microphone group. In particular, in this embodiment, the first and second microphone 30, 31 of the first microphone group are arranged together on a same side of the housing 101 whereas the first and second microphone 32, 33 of the second microphone group are arranged on opposite sides of the housing 201. It shall be noted, however, that other relative and or absolute arrangements of the four microphones 30, 31, 32, 33 are of course possible.

In this embodiment, the external speaker/microphone apparatus 100 comprises an audio cable 11 for connecting it to the electrical device, here, the smartphone. The external speaker/microphone apparatus 100 is adapted to detect whether or not it is connected via the audio cable 11 to the electrical device and (i) if a connection is detected, to use a cable mode for receiving audio signals via the audio cable 11 from the electrical device and/or for transmitting audio signals via the audio cable 11 to the electrical device, and (ii) if a connection is not detected, to use a wireless mode for receiving audio signals wirelessly from the electrical device and/or for transmitting audio signals wirelessly to the electrical device.

The audio cable 11 and its use with the external speaker/microphone apparatus 100 will be described in the following in more detail with reference to FIG. 3, which shows a second view (different from the first view) of the external speaker/microphone apparatus 100 shown in FIG. 1. (It shall be noted that in the second view, the first and the second speaker 20, 21 and the passive radiator 22 as well as the four microphones 30, 31, 32, 33 are omitted for reasons of clarity and comprehensibility.)

As can be seen from FIG. 3, in this embodiment, the audio cable 11 comprises an indicator element 14, e.g., a lighting element, such as an LED, for indicating to a user whether the external speaker/microphone apparatus 100 uses the cable mode. The indicator element 14 can be arranged, e.g., on an audio jack plug 60 of the audio cable 11.

Here, the external speaker/microphone apparatus 100 comprises two audio jack sockets 40, 50 and the audio cable 11 comprises two audio jack plugs 60, 70. The two audio jack plugs 60, 70 can be detachably coupled with the two audio jack sockets 40, 50, wherein the coupling is such that the audio cable 11 can be utilized by a user as a handle for carrying the external speaker/microphone apparatus 100. In this embodiment, the coupling makes use of at least magnetic force in order to ensure a sufficiently strong coupling between the two audio jack plugs 60, 70 and the two audio jack sockets 40, 50. Additionally or alternatively, however, it is also possible to make use of mechanical force, or a suitable locking mechanism may be used in order to provide, e.g., a positive locking, or a screw mechanism or the like.

In this embodiment, the two audio jack sockets 40, 50 each have four poles (not shown in the figures) and the external speaker/microphone apparatus 100 is adapted to switch a pole configuration of each of the audio jack sockets 40, 50 between at least (i) a first pole configuration, in which a first pole is configured to output audio signals that are based on audio signals acquired by at least one of the four microphones 30, 31, 32, 33, and in which a second and a third pole are configured to input audio signals for reproduction by the first and the second speaker 20, 21 and the passive radiator 22, and (ii) a second pole configuration, in which a first pole is configured to output audio signals that are based on audio signals acquired by at least the first microphone 32 of the second microphone group, in which a second pole is configured to output audio signals that are based on audio signals acquired by at least the second microphone 33 of the second microphone group, and in which a third pole is configured to input audio signals for reproduction by the first and the second speaker 20, 21 and the passive radiator 22.

It shall be noted that in some instances, the audio signals that are outputted by the first pole in the first pole configuration may be based on audio signals that are acquired by a mix of the four microphones 30, 31, 32, 33. Likewise, the audio signals that are outputted by the first and the second pole in the second pole configuration may each be based on audio signals that are acquired by a mix of the four microphones 30, 31, 32, 33.

The external speaker/microphone apparatus 100, here, is adapted to inform a user about a function and/or a status by means of a voice prompt. For instance, the external speaker/microphone apparatus 100 comprises one or more re-chargeable batteries (not shown in the figures) for providing electrical energy thereto and it can be adapted to reproduce an audio message such as “The batteries are running low!” or the like for informing a user about a low power status of the one or more batteries.

In this embodiment, the external speaker/microphone apparatus 100 is adapted to alternate, for the same function and/or status, between different voice prompts. So, taking again the above example, it could, at one time, reproduce the audio message “The batteries are running low!” and, at another time, it could reproduce another suitable audio message, such as “Only ten minutes left before the batteries are empty!” or the like. Of course, the external speaker/microphone apparatus 100 can be adapted to alternate between more than two voice prompts and the alternation can either be random or deterministic.

Additionally or alternatively, it is possible that the external speaker/microphone apparatus 100 is adapted to adapt at least one audio characteristic of the voice prompt to a corresponding at least one audio characteristic of a music reproduced by means of the first and the second speaker 20, 21 and the passive radiator 22. The at least one audio characteristic can include a rhythm and/or a pitch and/or a harmony and/or a volume. To give just a simple example: If the external speaker/microphone apparatus 100 currently reproduces a song by the first and the second speaker 20, 21 and the passive radiator 22 when the one or more batteries reach a low power status, the audio message “The batteries are running low!” can be overlaid on the currently reproduced song with a rhythm that is adapted to the rhythm thereof. In another example, the audio message is overlaid on the currently reproduced song with a volume that is as loud as (or slightly louder than) the volume thereof. Audio processing techniques such as music morphing, pitch modification and other algorithms are required for this purpose.

Instead of overlaying the voice prompt on a music that is currently reproduced by the first and the second speaker 20, 21 and the passive radiator 22, it can also be possible that the external speaker/microphone apparatus 100 is adapted to pause the currently reproduced music while reproducing the voice prompt. In this case, it may apply a cross-fade from the currently reproduced music to the voice prompt and vice versa.

The external speaker/microphone apparatus 100 can also be part of a system comprising a software program for being run by the electrical device, wherein the software program when being run by the electrical device allows a user to record and/or adapt a voice prompt. For instance, the user may be able to use the software program in order to record a voice prompt in his/her own natural voice for subsequent use by the external speaker/microphone apparatus 100.

It shall be noted that the housing 101 of the external speaker/microphone apparatus 100 comprises in a first region 103 at the outside a synthetic material, for example, a silicon, and is provided in a second region 104, which is, for example, made from a metal, at least partially with a plurality of holes for improving the passage of audio waves (only shown—as small dots—in FIG. 3). For instance, the first region 103 and the second region 104 can comprise twelve and eight, respectively, of the twenty flat surfaces 102 that form the shape of the housing 101 of the external speaker/microphone apparatus 100.

With returning reference to FIG. 1, in this embodiment, the external speaker/microphone apparatus 100 comprises an accelerometer 110 for measuring an acceleration and/or gravity thereof. In some embodiments, the external speaker/microphone apparatus 100 is adapted to control a function in dependence of the measured acceleration and/or gravity. For instance, it can be foreseen that the user can signal his/her wish to jump to a next song by simply shaking the external speaker/microphone apparatus 100. In response to the shaking, it can then communicate with the electrical device to request the next song to be transmitted—e.g., via the audio cable 11 in the cable mode or wirelessly in the wireless mode—to the external speaker/microphone apparatus 100.

Additionally or alternatively, the external speaker/microphone apparatus 100 can also be adapted to determine a misplacement thereof in dependence of the measured acceleration and/or gravity. For instance, it can be foreseen that the external speaker/microphone apparatus 100 can determine whether it is placed with an orientation that is generally suited for providing a good sound performance.

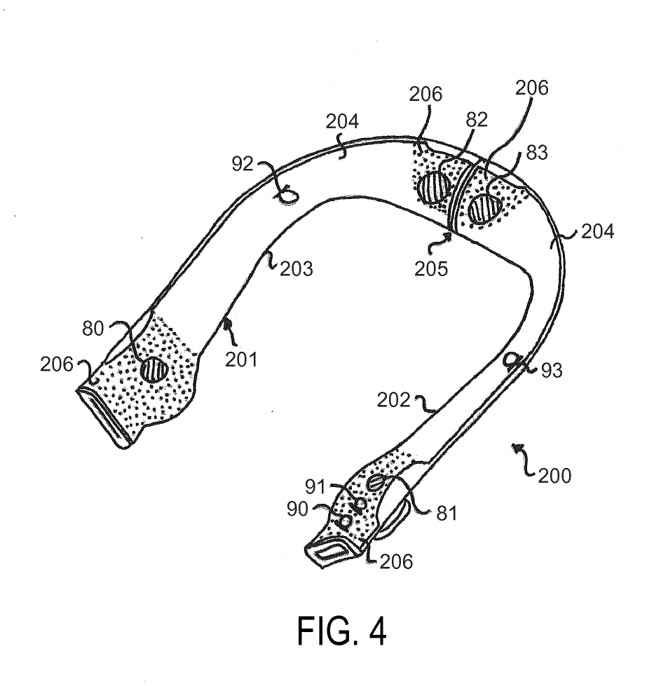

FIG. 4 shows schematically and exemplarily a first view of a second embodiment of an external speaker/microphone apparatus 200 for use with an electrical device (not shown in this figure) for providing audio signals and/or for voice communication. Again, it is assumed in the following that the electrical device is a smartphone.

The external speaker/microphone apparatus 200, in this embodiment, comprises a first and a second speaker 80, 81 for reproducing high and mid audio frequencies and a third and a fourth speaker 82, 83 for reproducing low audio frequencies, and four microphones 90, 91, 92, 93, as well as a housing 201 that encloses the first and the second speaker 80, 81, the third and the fourth speaker 82, 83, and the four microphones 90, 91, 92, 93. The shape of the housing 201 is formed, here, in substantially a U-shape for being worn by a user on the shoulders around the neck.

As in the first embodiment of an external speaker/microphone apparatus 100 described with reference to FIGS. 1 and 3 above, the four microphones 90, 91, 92, 93 constitute two different microphone groups. A first microphone group of the external speaker/microphone apparatus 200 comprises a first and a second microphone 90, 91 that are arranged with a distance therebetween between 1.5 cm and 1.8 cm. More generally, however, the first and the second microphone 90, 91 of the first microphone group may also be arranged with a distance therebetween between 1.3 cm and 2.0 cm or even between 1.0 cm and 2.3 cm. The external speaker/microphone apparatus 200 is adapted to simultaneously acquire first and second audio signals by means of the first and the second microphone 90, 91 of the first microphone group and to process the first and second audio signals using audio beamforming for providing a beamformed audio signal (see above).

A second microphone group of the external speaker/microphone apparatus 200 comprises a first and a second microphone 92, 93 that are arranged, in this embodiment, with a distance therebetween between 15 cm and 18 cm in order to mimic the distance between the ears in human perception. More generally, however, the first and the second microphone 92, 93 of the second microphone group may also be arranged with a distance therebetween between 13 cm and 20 cm or even between 11 cm and 22 cm. The external speaker/microphone apparatus 200 is adapted to simultaneously acquire first and second audio signals by means of the first and the second microphone 92, 93 of the second microphone group for providing binaural-like audio signals, i.e., audio signals that are intended to create a 3D stereo sound sensation for the listener (see above).

The housing 201 of the external speaker/microphone apparatus 200 comprises a first part 202 and a second part 203 that can be folded via a central hinge 205. Here, the first and the second microphone 90, 91 of the first microphone group are arranged in a same part, here, the first part 202, of the housing 201 near an end of the first part 202 that is opposite to an end at which the first part 202 is hinged to the second part of the housing 201 and the first and the second microphone 92, 93 of the second microphone group are respectively arranged in the first part 202 and the second part 203 on opposite sides of the housing 201. It shall be noted, however, that other relative and or absolute arrangements of the four microphones 90, 91, 92, 93 are of course possible.

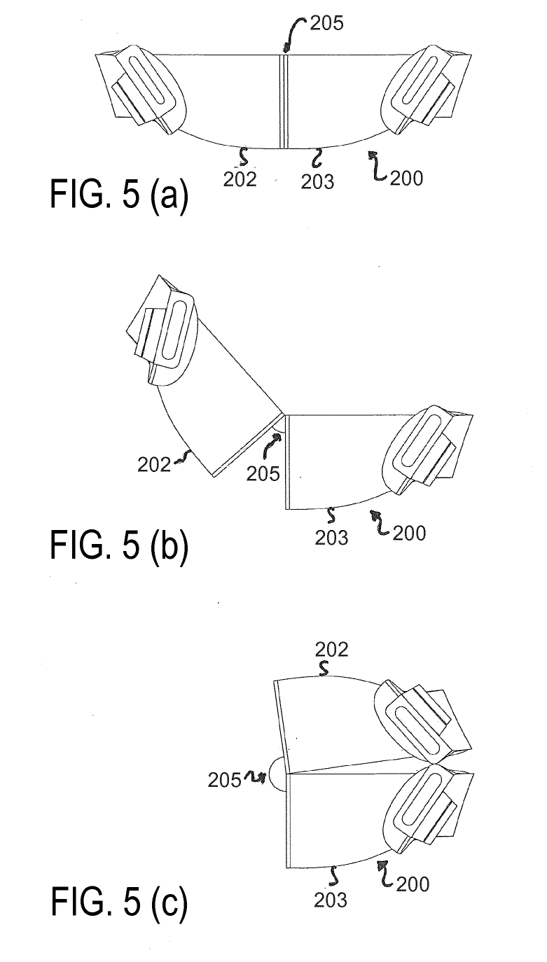

The folding of the first part 202 and the second part 203 of the housing 201 will be described in the following in more detail with reference to FIG. 5, which shows a second view (different from the first view) of the external speaker/microphone apparatus 200 shown in FIG. 4. (It shall be noted that in the second view, the first and the second speaker 80, 81 and the third and the fourth speaker 82, 83 as well as the four microphones 90, 91, 92, 93 are omitted for reasons of clarity and comprehensibility.)

FIG. 5 (a) shows the external speaker/microphone apparatus 200 in a completely un-folded configuration whereas FIG. 5 (c) shows it in a completely folded configuration. Additionally, a partly folded configuration of the external speaker/microphone apparatus 200 is shown in FIG. 5 (b).

Although the second embodiment of an external speaker/microphone apparatus 200 described with reference to FIGS. 4 and 5a-5c above is different in its form from the first embodiment of the external speaker/microphone apparatus 100 described with reference to FIGS. 1 and 3, it comprises the same or corresponding features and functionalities. For instance, although this is not explicitly shown in the figures, the external speaker/microphone apparatus 200 can also comprise an audio cable and audio jack sockets as described above. Moreover, it can also be adapted to inform a user about a function and/or a status by means of a voice prompt (see above) and it can also comprise an accelerometer for measuring an acceleration and/or gravity thereof. The above-described exemplary “Jump to the next song” control can then, e.g., be performed by a user by shrugging his/her shoulders when he/she wears the external speaker/microphone apparatus 200 on the shoulders around the neck.

It shall be noted that the housing 201 of the external speaker/microphone apparatus 200 comprises in a first region 204 at the outside a synthetic material, for example, a TPR (thermoplastic rubber), and is provided in a second region 206, which is, for example, made from a soft leatherette, at least partially with a plurality of holes for improving the passage of audio waves (only shown—as small dots—in FIG. 4).

Although in the first embodiment of an external speaker/microphone apparatus 100 described with reference to FIGS. 1 and 3 above, the external speaker/microphone apparatus 100 comprises a first and a second speaker 20, 21 and a passive radiator 22 for reproducing low audio frequencies, and in the second embodiment of an external speaker/microphone apparatus 200 described with reference to FIGS. 4 and 5 above, the apparatus 200 comprises a first and a second speaker 80, 81 for reproducing mid and high audio frequencies and a third and a fourth speaker 82, 83 for reproducing low audio frequencies, others embodiments of an external speaker/microphone apparatus can also comprise another number or combination of speakers and/or passive radiators. For instance, in one embodiment, an external speaker/microphone apparatus can comprise a first and a second speaker for reproducing mid and high audio frequencies and a third speaker for reproducing low audio frequencies, and, in another embodiment, an external speaker/microphone apparatus can comprise a first and a second speaker for reproducing mid and high audio frequencies, a third and a fourth speaker for creating surround sound audio, and a fifth speaker for reproducing low audio frequencies.

Although in the first embodiment of an external speaker/microphone apparatus 100 described with reference to FIGS. 1 and 3 above, the external speaker/microphone apparatus 100 comprises two audio jack sockets 40, 50 and the audio cable 11 comprises two audio jack plugs 60, 70, other embodiments can also comprise only one audio jack socket and the audio cable can only comprise one audio jack plug, wherein the audio jack plug can be detachably coupled with the audio jack plug such that the audio cable can be utilized by a user as a handle for carrying the external speaker/microphone apparatus. In this case, one end of the audio cable may be fixedly connected to the external speaker/microphone apparatus.

Although in the first embodiment of an external speaker/microphone apparatus 100 described with reference to FIGS. 1 and 3 above, the external speaker/microphone apparatus 100 comprises two audio jack sockets 40, 50 as two audio connectors that each have four poles, other embodiments can also comprises only one audio connector having four poles, wherein the external speaker/microphone apparatus is adapted to switch a pole configuration of the audio connector between at least (i) a first pole configuration, in which a first pole is configured to output audio signals that are based on audio signals acquired by at least one of the four microphones, and in which a second and a third pole are configured to input audio signals for reproduction by the first and the second speaker and the passive radiator, and (ii) a second pole configuration, in which a first pole is configured to output audio signals that are based on audio signals acquired by at least the first microphone of the second microphone group, in which a second pole is configured to output audio signals that are based on audio signals acquired by at least the second microphone of the second microphone group, and in which a third pole is configured to input audio signals for reproduction by the first and the second speaker and the passive radiator.

In the first embodiment of an external speaker/microphone apparatus 100 described with reference to FIGS. 1 and 3 above as well as in the second embodiment of an external speaker/microphone apparatus 200 described with reference to FIGS. 4 and 5a-5c above, the first microphone group comprises a first and a second microphone 30, 31 (respectively 90, 91), wherein the external speaker/microphone apparatus 100 (respectively 200) is adapted to simultaneously acquire first and second audio signals by means of the first and the second microphone 20, 21 (respectively 90, 91) of the first microphone group and to process the first and second audio signals using audio beamforming for providing a beamformed audio signal. In other embodiments, the first microphone group can also comprise a first, a second, and a third microphone, wherein the external speaker/microphone apparatus is adapted to simultaneously acquire first, second, and third audio signals by means of the first, the second, and the third microphone of the first microphone group and to process the first, second, and third audio signals using audio beamforming for providing a beamformed audio signal. In such embodiments, the first, the second, and the third microphone can be arranged, e.g., in a triangular configuration, in a substantially equilateral triangle.

In addition, it is possible in the first embodiment of an external speaker/microphone apparatus 100 described with reference to FIGS. 1 and 3 above as well as in the second embodiment of an external speaker/microphone apparatus 200 described with reference to FIGS. 4 and 5a-5c above that in the case where the first microphone group comprises a first and a second microphone 30, 31 (respectively 90, 91), the external speaker/microphone apparatus 100 (respectively 200) is adapted to process the first audio signal as a wanted signal and the second audio signal as an interference or room signal and to clean-up the first audio signal using the second audio signal for providing a cleaned-up audio signal. For this purpose, the second microphone 31 does not have to be arranged as close to the first microphone 30 as described above. For example, the second microphone 31 may be arranged on a different side of the external speaker/microphone apparatus 100 than the first microphone 30, and respectively similar for second microphone 91 may be arranged on a different side of the external speaker/microphone apparatus 200 than the first microphone 90.

Likewise, it is possible that in cases where the first microphone group comprises a first, a second, and a third microphone, the external speaker/microphone apparatus is adapted to process the first and second audio signals using audio beamforming for providing a beamformed audio signal, to process the third signal as an interference or room signal, and to clean-up the beamformed audio signal using the third audio signal for providing a cleaned-up beamformed audio signal. For this purpose, the third microphone does not have to be arranged close to the first and the second microphone. For example, the third microphone may be arranged on a different side of the external speaker/microphone apparatus than the first and the second microphone.

It shall be noted that the same or corresponding features and functionalities that are foreseen in the first embodiment of an external speaker/microphone apparatus 100 described with reference to FIGS. 1 and 3 above as well as in the second embodiment of an external speaker/microphone apparatus 200 described with reference to FIGS. 4 and 5a-5c above can also be utilized in other embodiments of an external speaker/microphone apparatus, e.g., in an external speaker/microphone apparatus that is configured as an over- or on-the-ear headphone, or as an in-ear phone, or that is arranged on glasses worn by a user.

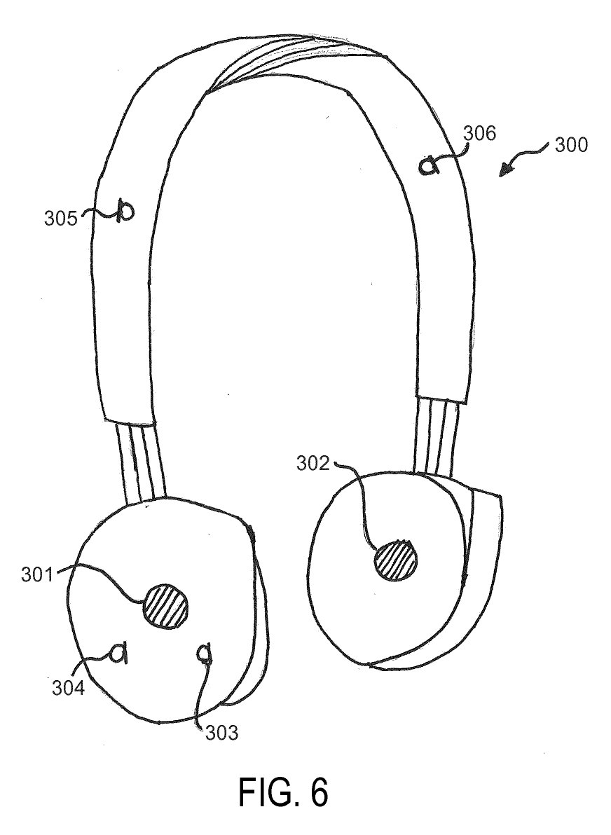

For instance, FIG. 6 shows schematically and exemplarily a view of a third embodiment of an external speaker/microphone apparatus 300 for use with an electrical device (not shown in this figure) for providing audio signals and/or for voice communication. Again, it is assumed in the following that the electrical device is a smartphone.

The external speaker/microphone apparatus 300, in this embodiment, comprises a first and a second speaker 301, 302 for reproducing audio frequencies, and four microphones 303, 304, 305, 306, wherein the external speaker/microphone apparatus 300 is configured as an over-the-ear headphone.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An external speaker/microphone apparatus for use with an electrical device for providing audio signals or for voice communication, comprising:
one or more speakers and one or more microphones; and
a housing that encloses the one or more speakers and the one or more microphones,
wherein the shape of the housing is formed from a number of twelve or more flat surfaces.

2. The external speaker/microphone apparatus according to claim 1, wherein each of the flat surfaces has the form of a regular polygon.

3. The external speaker/microphone apparatus according to claim 1, wherein the flat surfaces all have the same shape and size.

4. The external speaker/microphone apparatus according to claim 3, wherein the housing is formed in the shape of an icosahedron.

5. The external speaker/microphone apparatus according to claim 1, wherein an outside of the housing comprises a first region and a second region, wherein the second region includes a plurality of holes for improving the passage of audio waves.

6. An external speaker/microphone apparatus for use with an electrical device for providing audio signals or for voice communication, comprising:
one or more speakers and one or more microphones; and
a housing that encloses the one or more speakers and the one or more microphones,
wherein the shape of the housing is formed in substantially a U-shape for being worn by a user on the shoulders around the neck.

7. The external speaker microphone apparatus according to claim 6, wherein the housing comprises a first part and a second part that can be folded via a central hinge.

8. The external speaker/microphone apparatus according to claim 6, wherein the housing comprises a first region and a second region, wherein the second region includes a plurality of holes for improving the passage of audio waves.

9. (canceled)

10. The external speaker/microphone apparatus according to claim 1, wherein the one or more microphones comprise a first microphone group comprising a first and a second microphone, wherein the apparatus is adapted to simultaneously acquire first and second audio signals by means of the first and the second microphone of the first microphone group and to process the first and second audio signals using audio beamforming for providing a beamformed audio signal or to process the first audio signal as a wanted signal and the second audio signal as an interference or room signal and to clean-up the first audio signal using the second audio signal for providing a cleaned-up audio signal.

11. The external speaker/microphone apparatus according to claim 10, wherein the first and the second microphone of the first microphone group are arranged with a distance therebetween between 1.0 cm and 2.3 cm.

12. The external speaker/microphone apparatus according to claim 1, wherein the one or more microphones comprise a second microphone group comprising a first and a second microphone, wherein the apparatus is adapted to simultaneously acquire first and second audio signals by means of the first and the second microphone of the second microphone group for providing binaural-like audio signals.

13. The external speaker/microphone apparatus according to claim 12, wherein the first and the second microphone of the second microphone group are arranged with a distance therebetween between 6 cm and 18 cm.

14. The external speaker/microphone apparatus according to claim 10, wherein the first and the second microphone of the first microphone group are arranged in a plane that is perpendicular to a connecting line of a first and a second microphone of a second microphone group of the one or more microphones and that separates the connection line midway between the first and the second microphone of the second microphone group.

15. The external speaker/microphone apparatus according to claim 12, wherein the first and the second microphone of the second microphone group are arranged with a distance therebetween between 11 cm and 22 cm.

16. The external speaker/microphone apparatus according to claim 1, comprising:
an audio cable for connecting the apparatus to an electrical device for providing audio signals or for speech communication,
wherein the apparatus is adapted to detect whether or not it is connected via the audio cable to the electrical device, and
if a connection is detected, to use a cable mode for receiving audio signals via the audio cable from the electrical device or for transmitting audio signals via the audio cable to the electrical device, and
if a connection is not detected, to use a wireless mode for receiving audio signals wirelessly from the electrical device or for transmitting audio signals wirelessly to the electrical device.

17. The external speaker/microphone apparatus according to claim 16 wherein the audio cable comprises an indicator element for indicating to a user whether the apparatus uses the cable mode.

18. The external speaker/microphone apparatus according to claim 1, comprising:
at least one audio jack socket; and
an audio cable for connecting the apparatus to an electrical device for providing audio signals or for speech communication, wherein the audio cable comprises at least one audio jack plug,
wherein the at least one audio jack plug can be detachably coupled with the at least one audio jack socket, wherein the coupling is such that the audio cable can be utilized by a user as a handle for carrying the apparatus.

19. The external speaker/microphone apparatus according to claim 18, wherein the coupling makes use of at least magnetic force.

20. The external speaker/microphone apparatus according to claim 12, comprising:
at least one audio connector with at least four poles,
wherein the apparatus is adapted to switch a pole configuration of the audio connector between at least
a first pole configuration, in which a first pole is configured to output audio signals that are based on audio signals acquired by at least one of the one or more microphones, and in which a second and a third pole are configured to input audio signals for reproduction by at least one of the one or more speakers, and
a second pole configuration, in which a first pole is configured to output audio signals that are based on audio signals acquired by at least a first microphone of the second microphone group, in which a second pole is configured to output audio signals that are based on audio signals acquired by at least the second microphone of the second microphone group, and in which a third pole is configured to input audio signals for reproduction by at least one of the one or more speakers.

21. The external speaker/microphone apparatus according to claim 1, wherein the apparatus is adapted to inform a user about a function or a status utilizing a voice prompt, wherein the apparatus is adapted to alternate, for a same function or status, between different voice prompts.

22. The external speaker/microphone apparatus according to claim 1, wherein the apparatus is adapted to inform a user about a function or a status utilizing a voice prompt, wherein the apparatus is adapted to adjust at least one audio characteristic of the voice prompt according to a corresponding at least one audio characteristic of a music reproduced by at least one of the one or more speakers.

23. The external speaker/microphone apparatus according to claim 22, wherein the at least one audio characteristic includes at least one of: a rhythm, a pitch, a harmony, or a volume level.

24. The external speaker/microphone apparatus according to claim 1, wherein the apparatus is adapted to inform a user about a function or a status using a voice prompt, wherein the apparatus is adapted to apply a cross-fade from a music reproduced by at least one of the one or more speakers to the voice prompt and vice versa.

25. The external speaker/microphone apparatus according to claim 1, comprising:
an accelerometer for measuring an acceleration and/or gravity of the apparatus,
wherein the apparatus is adapted to control a function in dependence of the measured acceleration and/or gravity.

26. The external speaker/microphone apparatus according to claim 1, comprising:
an accelerometer for measuring an acceleration or gravity of the apparatus,
wherein the apparatus is adapted to determine a misplacement in dependence of the measured acceleration or gravity.

27. A system, comprising:
an external speaker/microphone apparatus, comprising:
one or more speakers and one or more microphones; and
a housing that encloses the one or more speakers and the one or more microphones, wherein the shape of the housing is formed from a number of twelve or more flat surfaces; and
a software program for being run by the electrical device for providing audio signals and/or for voice communication,
wherein the software program when being run by the electrical device allows a user to record and/or adapt a voice prompt.
